(19) United States
(12) Patent Application Publication
(10) Pub. No.: US 2024/0401749 A1
(43) Pub. Date: Dec. 5, 2024

(54) CRYOGENIC TANK WITH ACCESS OPENING, AND AIRCRAFT EQUIPPED THEREWITH

(71) Applicant: Airbus Operations GmbH, HAMBURG (DE)

(72) Inventor: Carsten PUSCHMANN, HAMBURG (DE)

(21) Appl. No.: 18/670,775

(22) Filed: May 22, 2024

(30) Foreign Application Priority Data
May 31, 2023 (EP) 23176491.1

(51) Int. Cl. F17C 13/06

(52) U.S. Cl. CPC F17C 13/06; F17C 2203/0391; F17C 2203/0629; F17C 2205/0311; F17C 2221/012; F17C 2223/0161

(57) ABSTRACT

A cryogenic tank for an aircraft providing a tank access for maintenance and repairing services of equipment inside the tank onboard of the aircraft. An access opening is closed by a removable closure including a multiple wall panel which is vacuum insulated and which is configured and fitted to the multiple tank wall in a manner that the heat ingress into the cryogenic tank is minimized and that no vacuum is impacted by opening and closing the removable closure.

### CROSS-REFERENCES TO RELATED APPLICATIONS

This application claims the benefit of the European patent application No. 23176491.1 filed on May 31, 2023, the entire disclosures of which are incorporated herein by way of reference.

### FIELD OF THE INVENTION

The invention relates to a cryogenic tank, especially for an aircraft, comprising a multiple tank wall. Further the invention relates to an aircraft comprising such an LH2 tank.

### BACKGROUND OF THE INVENTION

According to preferred embodiments, the cryogenic tank is a liquid hydrogen (LH2) tank for storing liquid hydrogen.

For technical background, reference is made to the following literature:
[1] DE 10 2014 107 316 A1
[2] US 2021/0 078 702A1
[3] WO 2021/148 335A1
[4] US 2023/0 002 069 A1
[5] EP 4 119 834 A1
[6] EP 4 124 568 A1
[7] EP 4 124 790 A1
[8] Product Sheet: Demaco-Cryogenics Johnston Coupling, download on 23 Dec. 2023

References [1] to [3] relate to hydrogen installations in an aircraft. References [4] to [7] relate to cryogenic tanks, especially liquid hydrogen tanks (LH2 tanks), for an aircraft and to aircraft with such a cryogenic tank. Reference [8] relates to a so-called Johnston coupling for coupling cryogenic pipe section.

Lightweight energy storage is a key topic for next generation aircraft. Hydrogen offers high energy densities, whereas the storage technique (cryogenic, compressed, solid state/absorbed) is a key issue. Hydrogen can be compressed and/or cooled down to cryogenic temperatures to increase the volumetric and gravimetric energy density. Usually, complex tank systems are needed with individual requirements to the materials, design and working principle, e.g., regarding operational safety.

Compressed and cryogenic hydrogen are the techniques of choice for today's vehicles, like cars or airplanes. Cryogenic tanks can achieve the lowest fuel volume/fuel mass ratio. LH2 tanks should have a very good thermal insulation.

### SUMMARY OF THE INVENTION

It is an object of the invention to improve hydrogen tanks for use in vehicles, such as aircraft.

The invention provides for a cryogenic tank, especially an LH2 tank, comprising a multiple tank wall, an access opening in the multiple tank wall allowing access to an interior of the cryogenic tank for maintenance or repair services and a closure for closing the access opening,
wherein the multiple tank wall includes an inner tank wall skin, an outer tank wall skin and a tank wall vacuum insulation space between the inner tank wall skin and the outer tank wall skin,
wherein the closure comprises a multiple wall panel that includes an outer panel wall, an inner panel wall and a panel vacuum insulation space between the outer panel wall and the inner panel wall.

Preferably, the closure further includes a multiple wall closure ring with an outer closure ring wall, an inner closure ring wall and a closure ring vacuum insulation space between the outer and inner closure ring walls.

Preferably, a first end of the multiple wall closure ring is tightly closed and a second end of the multiple wall closure ring is tightly connected to the multiple wall panel so that the panel vacuum insulation space and the closure ring vacuum insulation space share a common interspace vacuum volume.

Preferably, the closure has a vacuum port for evacuation of the common interspace vacuum volume.

Preferably, a multilayer insulation is fitted inside the common interspace vacuum volume.

Preferably, the access opening in the multiple tank wall includes a multiple wall tank ring with an outer tank ring wall, an inner tank ring wall and a tank ring vacuum insulation space between the outer and inner tank ring walls.

Preferably, the ends of the multiple wall tank ring are tightly closed and the outer tank ring wall is tightly connected to the outer and inner tank wall skin so that the tank wall vacuum insulation space and the tank ring vacuum insulation space share a common interspace vacuum volume.

Preferably, the multiple wall closure ring is insertable in the tank multiple ring wall for closing the access opening.

Preferably, the inner side of the inner tank ring wall and the outer side of the outer closure ring wall have smooth surfaces configured to create of a tight fit between each other when the access opening is closed by the closure.

Preferably, the access opening has a tank flange and the closure has a closure flange which mates to the tank flange so that in a closed state the closure flange is tightly connected, especially by a number of bolt and screw assemblies, to the tank flange.

Preferably, at least one pipe runs through the closure and has a multiple wall pipe section fixed to the closure.

Preferably, the multiple wall section has an inner pipe wall and an outer pipe wall with a pipe vacuum insulation space therebetween.

Preferably, the pipe vacuum insulation space and the panel vacuum insulation space share a common interspace vacuum volume.

Preferably, the multiwall pipe section extends from the inner panel wall and the outer pipe wall is connected to the inner panel wall.

Alternatively, the multiwall pipe section extends from the outer panel wall and the outer pipe wall is connected to the outer panel wall.

Preferably, several of the pipes run through the closure and are fixed to the inner and outer panel walls as a structural support and/or in order to maintain the distance between the inner and outer panel walls.

According to another aspect, the invention provides an aircraft comprising a cryogenic tank according to any of the preceding embodiments.

Preferred embodiments of the invention relate to a vacuum insulated access panel for a cryogenic tank such as a liquid hydrogen tank (LH2 tank).

Preferred embodiments of the invention improve the design of a liquid hydrogen tank. Preferably, the tank is of the double wall vacuum insulated design, which is the state of art tank design for such applications. Embodiments of the invention allow to open the tank and get access to the inner part without breaking the tank vacuum. Preferred uses of such design are on hydrogen powered aircraft.

Currently, hydrogen tanks are completely closed, normally by welding. It is impossible to get access to the inner part of the tank without cutting the welds or the tank structure. Hence, equipment or installations inside the tank can only be maintained or replaced with a large effort. As a consequence, normally the complete tank needs to be removed from the aircraft and repaired in a shop outside the aircraft.

Some conventional aircraft fuel tanks have access openings allowing access to the interior of the fuel tank on board of the aircraft for repair and maintenance purposes. With embodiments of the invention, such a tank access for maintenance and repair can now also be provided for liquid hydrogen tanks or other cryogenic tank to be used on aircraft. In embodiments of the invention, the tank access opening is closed by a closure including a panel. In some embodiments, this panel is double walled and vacuum insulated. The panel is designed and fitted to the tank in manner that the heat ingress into the cold hydrogen is minimized.

### BRIEF DESCRIPTION OF THE DRAWINGS

Embodiments of the invention are explained below referring to the accompanying drawings in which:

FIG. 1 depicts an aircraft having a cryogenic tank;

FIG. 2 is a sectional view through a part of the cryogenic tank (e.g., a top part) with an access opening and a closure for this access opening in a closed state;

FIG. 3 is a sectional view as in FIG. 2 wherein the access opening and the closure are in an open state;

FIG. 4 is a perspective view of the part of the cryogenic tank with the access opening and the closure in the closed state; and

FIG. 5 is a perspective view of the part of the cryogenic tank with the access opening and the closure in the open state.

### DETAILED DESCRIPTION OF THE PREFERRED EMBODIMENTS

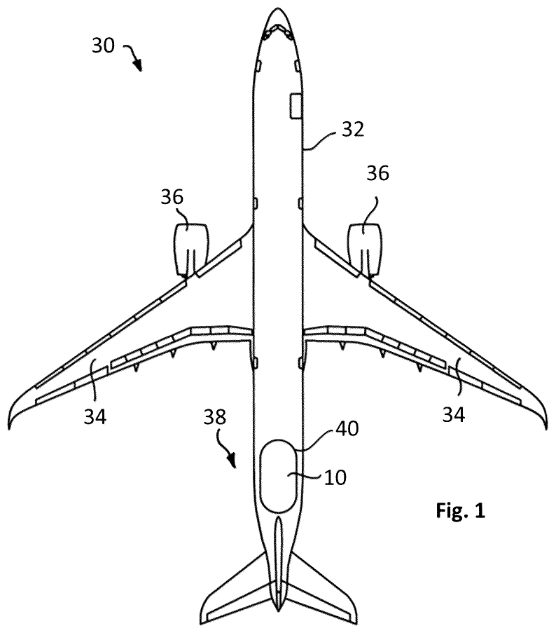

Referring to FIG. 1, an aircraft 30 comprises a fuselage 32. The aircraft 30 further comprises a pair of wings 34 that are attached to the fuselage 32. Furthermore, an engine 36 is attached to each wing 34.

The aircraft 30 comprises an aft section 38, which includes a horizontal and vertical tail plane. Furthermore, the aircraft 30 comprises a tank arrangement 40.

The tank arrangement 40 includes a cryogenic tank 10 that is preferably arranged in the aft section 38. It should be noted that the cryogenic tank 10 may have a different shape and/or be located in a different section of the aircraft 30.

The tank 10 includes hydrogen fuel that can be directly fed to the engines 36. The hydrogen fuel may also be fed to fuel cells (not depicted) where the hydrogen is converted into electrical energy, and the electrical energy is then fed to the engines 36. The hydrogen fuel is stored in the tank 10 in the form of a cryogenic liquid, i.e., liquid hydrogen (LH2).

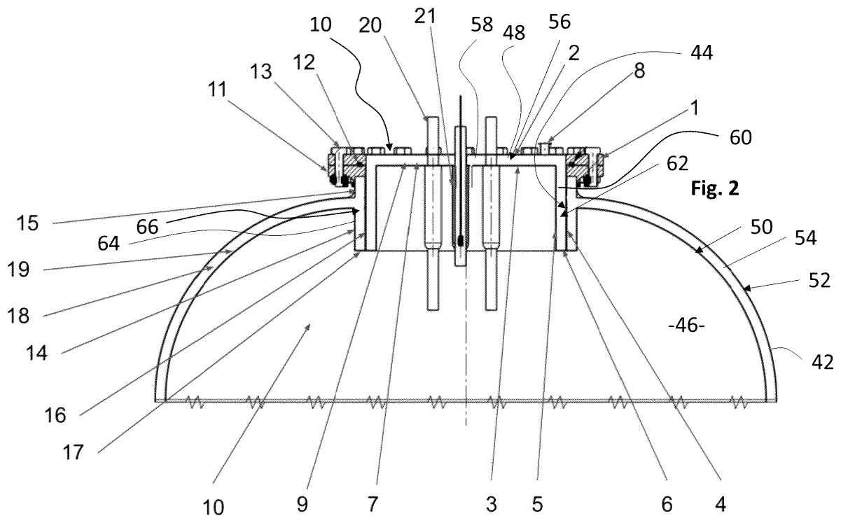

Referring to FIGS. 2 to 5, an embodiment of the cryogenic tank 10 is explained in more detail.

The cryogenic tank 10 comprises a multiple tank wall 42, an access opening 44 in the multiple tank wall 42 allowing access to an interior 46 of the cryogenic tank 10 for maintenance or repair services and a closure 48 for closing the access opening 44.

In the embodiment shown, the cryogenic tank 10 is a double walled tank 10 wherein the multiple tank wall 42 includes an inner tank wall skin 50, an outer tank wall skin 52 and a tank wall vacuum insulation space 54 between the inner tank wall skin 50 and the outer tank wall skin 52.

The closure 48 comprises a multiple wall panel 56 that includes an outer panel wall 2, an inner panel wall 3 and a panel vacuum insulation space 58 between the outer panel wall 2 and the inner panel wall 3.

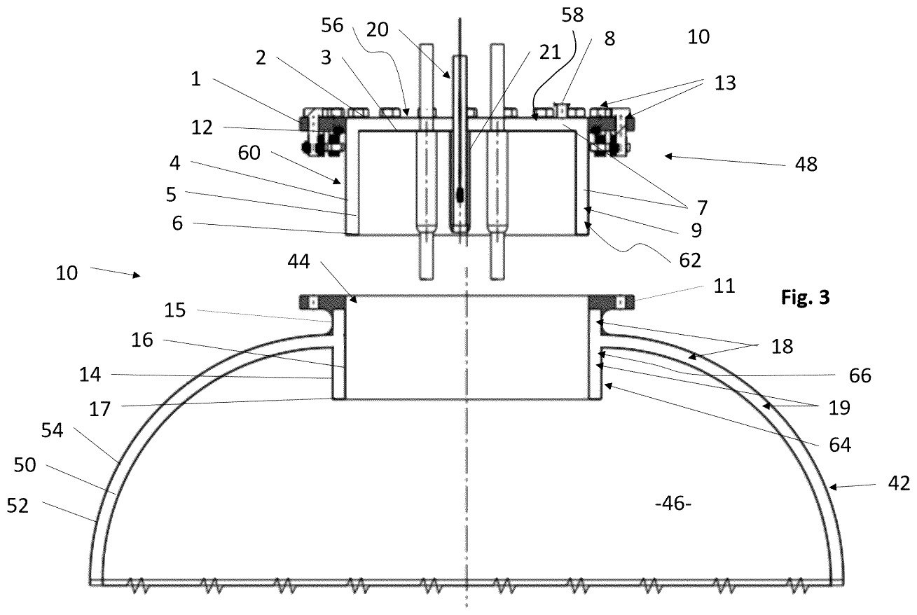

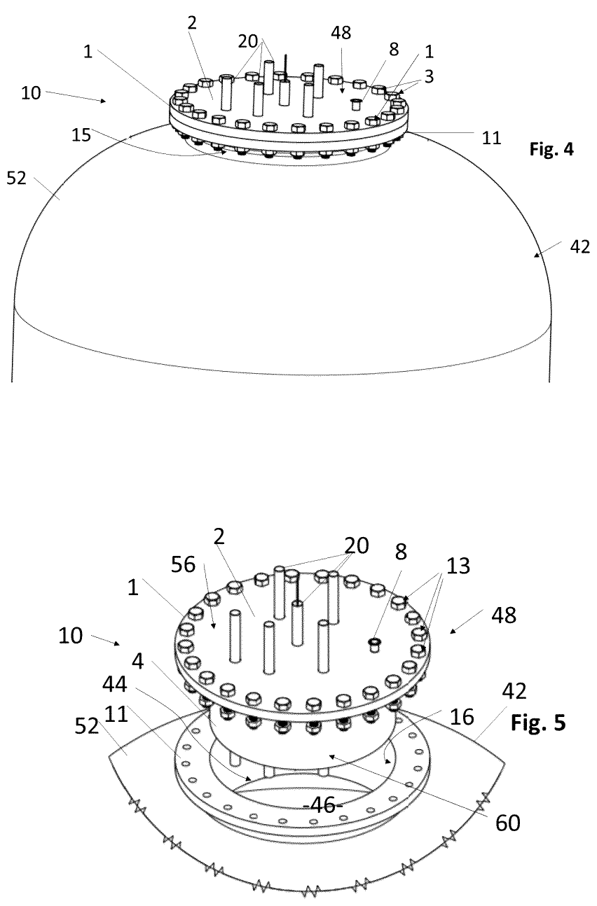

In the embodiments shown, the access opening 44 is arranged in a top part of the cryogenic tank 10. FIG. 2 shows a sectional view through this top part in the closed state, FIG. 3 shows the sectional view in the open state; FIG. 4 shows a perspective view in the closed state and FIG. 5 shows the perspective view in the open state.

In the embodiments shown, the multiple wall panel 56 is a double walled access panel. This panel 56 has a panel flange 1, an upper wall as the outer panel wall 2 and a lower wall as the inner panel wall 3.

In some embodiments, the closure 48 further includes a multiple wall closure ring 60 with an outer closure ring wall 4, an inner closure ring wall 5 and a closure ring vacuum insulation space 62 between the outer and inner closure ring walls 4, 5.

Referring to FIGS. 2 to 5, the multiple wall closure ring 60 is a kind of “shaft” attached to panel 56. This shaft consists of an outer ring as outer closure ring wall 4, an inner ring as inner closure ring wall 5 and a lower closing plate 6.

All these parts 1, 2, 3, 4, 5 and 6 are welded together to create a single closure interspace volume 7—constituted, e.g., by the panel vacuum insulation space 58 and the closure ring vacuum insulating space 62 that are combined in fluid communication at the edge region of the closure 44. The air in this volume 7 can be extracted through a vacuum port 8. A Multi-Layer Insulation (MLI—not shown in detail) 9 is fitted inside the closure interspace volume 7.

On the side of the multiple tank wall 42 there is another flange—tank flange 11—mounted at the multiple tank wall 42, that meets the panel flange 1. A seal 12 is installed between the tank flange 11 and the panel flange 1. The flanges 1, 11 are bolted together by a number of bolt and screw assemblies 13.

In some embodiments, the multiple tank wall 42 includes a multiple wall tank ring 64 with an outer tank ring wall arrangement 14, 15, an inner tank ring wall 16 and a tank ring vacuum insulation space 66 between the outer and inner tank ring walls 14, 15, 16. In some embodiments, the outer tank ring wall arrangement comprises an inside outer tank ring wall 14 arranged inside of the inner tank wall skin 50 and an outside outer tank ring wall 15 arranged outside of the outer tank wall skin 52. In the embodiments shown, the multiple wall tank ring 64 is a kind of “shaft” connected to the tank flange 11. This shaft consists of the inside outer tank ring wall 14 (e.g., a lower outer ring made from the tank wall material), the outside outer tank ring wall 15 (e.g., an upper outer ring made from the tank wall material), the inner tank ring wall 16 (e.g., an inner ring made from the tank wall material), and an inside closing plate 17 (e.g., a lower closing plate made from the tank wall material for closing the inside end of the multiple wall tank ring 64). The other end of the multiple wall tank ring 64 is tightly closed by the tank flange 11.

All the tank side parts 11, 14, 15, 16, 17, 50, and 52 are welded to form the multiple tank wall 42 with the access opening 44 defined by the multiple wall tank ring 64. A single tank wall interspace volume 18 is created within the multiple tank wall 42. In other words, the vacuum insulation spaces 54, 66 between the skins 50, 52 and between the tank ring walls 14, 15, 16 are combined into the single tank wall interspace volume 18. This tank wall interspace volume 18 is also thermally insulated by a Multi-Layer Insulation (MLI-not shown in detail) 19.

The outer side of the outer closure ring wall 4 and the inner side of the inner tank ring wall 16 have smooth surface which are, in the closed state, in close contact to each other such that a tight fit is created. A seal 12 is installed at the panel flange 1 to avoid hydrogen from leaking out of the tank 10.

Pipes 20 that are running into the cryogenic tank 10 are routed through the access panel 56. The pipes 20 are fitted with a double walled section 21 to minimize heat ingress along the pipes 20. This double walled section 21 is at one end-here shown at the top-open into the closure interspace volume 7 and creates a common vacuum with the other parts of the panel 56. At the other end-here shown at the bottom-it is closed to the pipe by welding (not shown). The interior of the double walled section 21 is insulated by Multi-Layer Insulation (MLI-not shown).

The pipes 20 also serve as a structural support, they ensure the distance between the outer panel wall 2 and the inner panel wall 3.

In the embodiments shown, the double walled section 21 extends into the interior 46 of the tank, it is also possible that double walled section is arranged outside for thermally insulating a cold inner pipe running into the interior of the tank.

A cryogenic tank 10 for an aircraft 30 has been described which is providing a tank access for maintenance, inspection and repair inside the tank onboard of the aircraft 30. An access opening 44 is closed by a removable closure 48 including a multiple wall panel 56 which is vacuum insulated and which is designed and fitted to the multiple tank wall 42 in a manner that the heat ingress into the cryogenic tank 10 is minimized. An advantage is that no vacuum is impacted by opening and closing the removable closure 48.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGN LIST

1 panel flange
2 outer panel wall
3 inner panel wall
4 outer closure ring wall
5 inner closure ring wall
6 closure plate
7 closure interspace volume
8 vacuum port
9 Multi-Layer Insulation (in closure interspace volume)
10 cryogenic tank
11 tank flange
12 seal
13 bolt and screw arrangement
14 inside outer tank ring wall
15 outside outer tank ring wall
16 inner tank ring wall
17 end plate (of the multiple wall tank ring)
18 tank wall interspace volume
19 Multi-Layer Insulation (in the tank wall interspace volume)
20 pipe
21 double wall section
30 aircraft
32 fuselage
34 wing
36 engine
38 aft section
40 tank arrangement
42 multiple tank wall (e.g., double tank wall)
44 access opening
46 interior of the tank
48 closure
50 inner tank wall skin
52 outer tank wall skin
54 tank wall insulation space
56 panel
58 panel vacuum insulation space
60 multiple wall closure ring
62 closure ring vacuum insulation space
64 multiple wall tank ring
66 tank ring vacuum insulation space

1. A cryogenic tank comprising:
a multiple tank wall,
an access opening in the multiple tank wall allowing access to an interior of the cryogenic tank for at least one of maintenance, repair or replacement services, and
a removable closure for closing the access opening,
wherein the multiple tank wall includes an inner tank wall skin, an outer tank wall skin and a tank wall vacuum insulation space between the inner tank wall skin and the outer tank wall skin, and
wherein the closure comprises a multiple wall panel that includes an outer panel wall, an inner panel wall and a panel vacuum insulation space between the outer panel wall and the inner panel wall.

2. The cryogenic tank according to claim 1, wherein the closure further includes a multiple wall closure ring with an outer closure ring wall, an inner closure ring wall and a closure ring vacuum insulation space between the outer and inner closure ring walls.

3. The cryogenic tank according to claim 2, wherein a first end of the multiple wall closure ring is tightly closed and a second end of the multiple wall closure ring is tightly connected to the multiple wall panel so that the panel vacuum insulation space and the closure ring vacuum insulation space form a single closure interspace vacuum volume.

4. The cryogenic tank according to claim 3, wherein the closure has a vacuum port for evacuation of the closure interspace vacuum volume.

5. The cryogenic tank according to claim 3, wherein a multilayer insulation is fitted inside the closure interspace vacuum volume.

6. The cryogenic tank according to claim 1, wherein the access opening in the multiple tank wall is defined by a multiple wall tank ring with an outer tank ring wall arrangement, an inner tank ring wall and a tank ring vacuum insulation space between the outer and inner tank ring walls.

7. The cryogenic tank according to claim 6, wherein ends of the multiple wall tank ring are tightly closed.

8. The cryogenic tank according to claim 6, wherein the outer tank ring wall arrangement comprises an inside outer tank ring wall arranged inside the inner tank wall skin and an outside outer tank ring wall arranged outside the outer tank wall skin.

9. The cryogenic tank according to claim 6, wherein the outer tank ring wall arrangement is tightly connected to the outer and inner tank wall skin so that the tank wall vacuum insulation space and the tank ring vacuum insulation space that at least one of
are in fluid communication with each other, or
form a single tank wall interspace vacuum volume.

10. The cryogenic tank according to claim 6, wherein
the closure further includes a multiple wall closure ring with an outer closure ring wall, an inner closure ring wall and a closure ring vacuum insulation space between the outer and inner closure ring walls, and
the multiple wall closure ring is insertable in the multiple wall tank ring for closing the access opening.

11. The cryogenic tank according to claim 6, wherein
the closure further includes a multiple wall closure ring with an outer closure ring wall, an inner closure ring wall and a closure ring vacuum insulation space between the outer and inner closure ring walls, and
the inner side of the inner tank ring wall and the outer side of the outer closure ring wall have smooth surfaces configured to create of a tight fit between each other when the access opening is closed by the closure.

12. The cryogenic tank according to claim 1, wherein the access opening has a tank flange and the closure has a closure flange which mates to the tank flange so that in a closed state the closure flange is tightly connected, by a number of bolt and screw assemblies, to the tank flange.

13. The cryogenic tank according to claim 1, wherein at least one pipe runs through the closure and has a multiple wall pipe section fixed to the closure.

14. The cryogenic tank according to claim 13, wherein the multiple wall section has an inner pipe wall and an outer pipe wall with a pipe vacuum insulation space therebetween, such that the pipe vacuum insulation space is in fluid communication with the panel vacuum insulation space.

15. The cryogenic tank according to claim 13, wherein the multiple wall section has an inner pipe wall and an outer pipe wall with a pipe vacuum insulation space therebetween, such that the multiple wall section extends from the inner panel wall and the outer pipe wall is connected to the inner panel wall.

16. The cryogenic tank according to claim 13, wherein the multiple wall section has an inner pipe wall and an outer pipe wall with a pipe vacuum insulation space therebetween, such that the multiple wall section extends from the outer panel wall and the outer pipe wall is connected to the outer panel wall.

17. The cryogenic tank according to claim 13, wherein several of the pipes run through the closure and are fixed to the inner and outer panel walls as a structural support.

18. The cryogenic tank according to claim 13, wherein several of the pipes run through the closure and are fixed to the inner and outer panel walls to maintain a distance between the inner and outer panel walls.

19. An aircraft comprising a cryogenic tank according to claim 1.
